(19) United States
(12) Patent Application Publication
(10) Pub. No.: US 2025/0214336 A1
(43) Pub. Date: Jul. 3, 2025

(54) METHOD OF DRIVING LIQUID EJECTING APPARATUS

(71) Applicant: SEIKO EPSON CORPORATION, Tokyo (JP)

(72) Inventor: Akira MIYAGISHI, SHIOJIRI-SHI (JP)

(21) Appl. No.: 19/003,102

(22) Filed: Dec. 27, 2024

(30) Foreign Application Priority Data
Dec. 28, 2023 (JP) 2023-222301

(51) Int. Cl. B41J 2/045; B41J 2/14

(52) U.S. Cl. CPC B41J 2/04588; B41J 2/04541; B41J 2/0457; B41J 2/04573; B41J 2/04581; B41J 2/04596; B41J 2/14233

(57) ABSTRACT

A method of driving a liquid ejecting apparatus including a piezoelectric element, and a pressure chamber. The method includes: generating a plurality of pairs of first drive signals and second drive signals, the first drive signals include electrical potential-changing elements that change in electrical potential, and the second drive signals that include electrical potential-maintained elements that maintain fixed electrical potentials, and detecting, as a plurality of residual vibration signals for the plurality of pairs, variations in electromotive force of the piezoelectric element according to variations in residual pressure that is applied to liquid in the pressure chamber after every supplying the electrical potential-changing element and the electrical potential-maintained element to the piezoelectric element for the plurality of the pairs, and identifying a first deformation property of the piezoelectric element based on the plurality of residual vibration signals for the plurality of pairs.

The present application is based on, and claims priority from JP Application Serial Number 2023-222301, filed Dec. 28, 2023, the disclosure of which is hereby incorporated by reference herein in its entirety.

### BACKGROUND

### 1. Technical Field

The present disclosure relates to a method of driving a liquid ejecting apparatus.

### 2. Related Art

A liquid ejecting apparatus that ejects liquid such as ink onto a medium such as a printing sheet has been proposed.

A liquid ejecting apparatus described in JP-A-2018-140642 includes a nozzle plate having a nozzle for ejecting ink, a flow path substrate having a pressure chamber provided corresponding to the nozzle, and a piezoelectric element that changes the pressure of the ink in the pressure chamber. The piezoelectric element includes an upper electrode, a lower electrode, and a piezoelectric body disposed between the upper electrode and the lower electrode. The piezoelectric body deforms according to an applied drive voltage, that is, a difference in electrical potential between an upper electrode film and a lower electrode film. The deformation of the piezoelectric body is used to cause a fluctuation in the pressure applied to the ink in the pressure chamber and thereby cause a droplet to be ejected from the nozzle.

In the liquid ejecting apparatus, a drive voltage according to an amount of liquid to be ejected from the nozzle is set based on piezoelectric properties of the piezoelectric body.

In general, the piezoelectric properties of the piezoelectric body are measured during the manufacture of the liquid ejecting apparatus. However, the piezoelectric properties of the piezoelectric body change as a period of time when the liquid ejecting apparatus performs printing increases. Therefore, when the drive voltage based on the piezoelectric properties set during the manufacture is used, an amount of liquid ejected from the nozzle may gradually change. As a result, a color difference or the like may occur and affect the printing quality.

### SUMMARY

According to an aspect of the present disclosure, a method of driving a liquid ejecting apparatus including a piezoelectric element having a first electrode, a second electrode, and a piezoelectric body disposed between the first electrode and the second electrode, a pressure chamber having a volume that changes according to deformation of the piezoelectric element, a drive signal generator that generates a plurality of pairs of first drive signals that are supplied to the first electrode and include electrical potential-changing elements that change in electrical potential over predetermined electrical potential differences from starting electrical potentials to ending electrical potentials, and second drive signals that are supplied to the second electrode and include electrical potential-maintained elements that maintain fixed electrical potentials, and a detector that detects, as residual vibration signals for the respective pairs, variations in electromotive force of the piezoelectric element according to variations in residual pressure applied to liquid in the pressure chamber after the electrical potential-changing elements are supplied to the first electrode and the electrical potential-maintained elements are supplied to the second electrode includes: making different differences between the ending electrical potentials of the electrical potential-changing elements of the first drive signals and the electrical potentials of the electrical potential-maintained elements of the second drive signals in the plurality of pairs; and causing the detector to identify a first deformation property of the piezoelectric element based on the residual vibration signals for the plurality of pairs.

### BRIEF DESCRIPTION OF THE DRAWINGS

FIG. 1 is a schematic diagram illustrating an example of a configuration of a liquid ejecting apparatus according to a first embodiment.

FIG. 2 is a diagram illustrating an electrical configuration of the liquid ejecting apparatus according to the first embodiment.

FIG. 3 is a sectional view for explaining a configuration of a head chip illustrated in FIG. 2.

FIG. 4 is a diagram illustrating an example of a configuration of a drive controller illustrated in FIG. 2.

FIG. 5 is a diagram for explaining waveforms included in a drive signal according to the first embodiment.

FIG. 6 is a diagram illustrating a residual vibration signal.

FIG. 7 is a diagram for explaining a method of driving the liquid ejecting apparatus according to the first embodiment.

FIG. 8 is a diagram for explaining step S01 and step S02 that are included in each of first step S1 and second step S2 illustrated in FIG. 7.

FIG. 9 is a diagram for explaining step S01.

FIG. 10 is a diagram illustrating changes over time in order to explain step S01.

FIG. 11 is a graph illustrating a relationship between a spectral intensity and a difference between electrical potentials.

FIG. 12 illustrates a model equation for curve fitting processing.

FIG. 13 is a diagram for explaining step S01 according to a second embodiment.

### DESCRIPTION OF EMBODIMENTS

Hereinafter, preferred embodiments of the present disclosure will be described with reference to the accompanying drawings. In the drawings, dimensions and scale of each of sections may be different from the actual dimensions and scale of each of the sections, and some portions are schematically illustrated for ease of understanding. The scope of the present disclosure is not limited to the embodiments unless specifically stated to limit the present disclosure in the following description.

In the following description, an X axis, a Y axis, and a Z axis that intersect each other are used. One of directions that are along the X axis is an X1 direction, and the opposite direction to the X1 direction is an X2 direction. Similarly, directions that are along the Y axis and are opposite to each other are a Y1 direction and a Y2 direction. Directions that are along the Z axis and are opposite to each other are a Z1 direction and a Z2 direction. Typically, the Z axis is a vertical axis, and the Z2 direction corresponds to a downward direction in the vertical direction. However, the Z axis may not be the vertical axis. In addition, the X axis, the Y axis, and the Z axis are typically perpendicular to each other but are not limited thereto. For example, the X axis, the Y axis, and the Z axis may intersect each other at an angle of 80° degrees or greater and 100° degrees or less.

### A: First Embodiment

### A1: Overall Configuration of Liquid Ejecting Apparatus

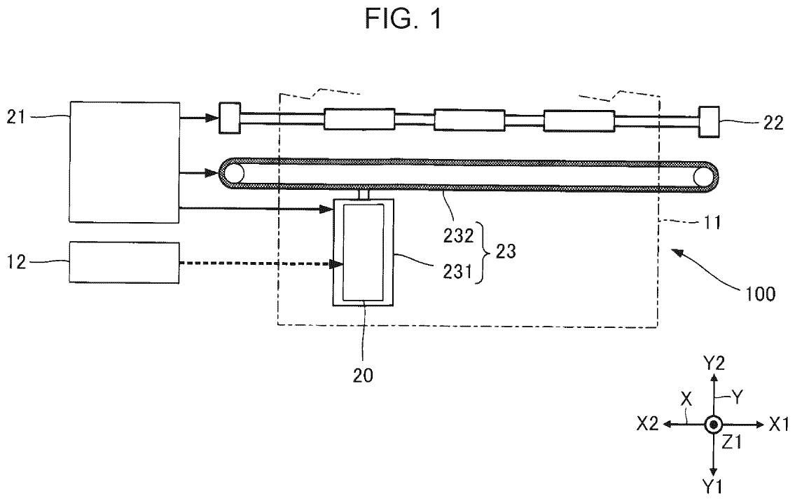

FIG. 1 is a schematic diagram illustrating an example of a configuration of a liquid ejecting apparatus 100 according to a first embodiment. The liquid ejecting apparatus 100 is an ink jet printing apparatus that ejects liquid such as ink as a droplet onto a medium 11. The medium 11 is, for example, a printing sheet. The medium 11 is not limited to the printing sheet. For example, the medium 11 may be a printing target of any material such as a resin film or fabric.

As illustrated in FIG. 1, the liquid ejecting apparatus 100 includes a liquid container 12, a control unit 21, a transport mechanism 22, a moving mechanism 23, and a liquid ejecting head 20.

The liquid container 12 stores ink. Specific aspects of the liquid container 12 include a cartridge detachably attachable to the liquid ejecting apparatus 100, a bag-shaped ink pack including a flexible film, and an ink tank that can be filled with the ink. The type of the ink stored in the liquid container 12 is arbitrary.

The control unit 21 controls operations of the sections of the liquid ejecting apparatus 100. The control unit 21 includes, for example, one or more processing circuits such as a central processing unit (CPU) or a field-programmable gate array (FPGA), and one or more storage circuits such as a semiconductor memory.

The transport mechanism 22 transports the medium 11 in the Y1 direction under control by the control unit 21. The moving mechanism 23 causes the liquid ejecting head 20 to reciprocate along the X axis under control by the control unit 21. The moving mechanism 23 includes a substantially box-shaped carriage 231 storing the liquid ejecting head 20, and an endless transport belt 232 to which the carriage 231 is fixed. The number of liquid ejecting heads 20 mounted on the carriage 231 is not limited to one and may be two or more. In addition, in addition to the liquid ejecting head 20, the liquid container 12 described above may be mounted on the carriage 231.

The liquid ejecting head 20 ejects the ink supplied from the liquid container 12 onto the medium 11 from each of a plurality of nozzles under control by the control unit 21 based on print data Img. The ejection is performed in parallel with the transport of the medium 11 by the transport mechanism 22 and the reciprocating movement of the liquid ejecting head 20 by the moving mechanism 23 such that an image corresponding to the print data Img is formed with the ink on a surface of the medium 11.

### A2: Electrical Configuration of Liquid Ejecting Apparatus 100

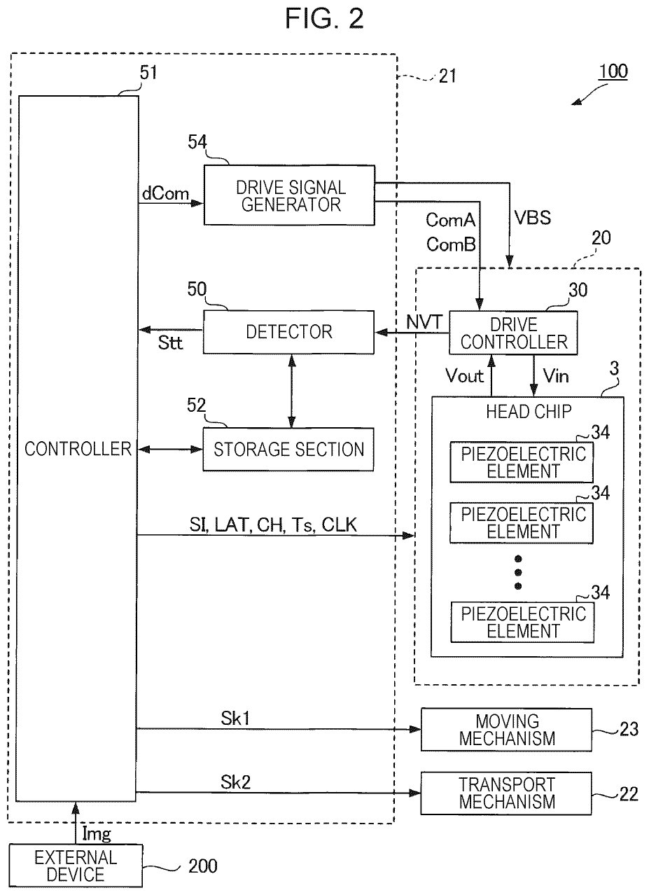

FIG. 2 is a diagram illustrating an electrical configuration of the liquid ejecting apparatus 100 according to the first embodiment. As illustrated in FIG. 2, the liquid ejecting head 20 includes a head chip 3 and a drive controller 30. In an example illustrated in FIG. 2, one head chip 3 is illustrated, but a plurality of head chips 3 may be provided.

The head chip 3 includes a plurality of piezoelectric elements 34. The drive controller 30 switches, under control by the control unit 21, whether to supply a drive signal Com output from the control unit 21 as a supply drive signal Vin to each of the plurality of piezoelectric elements 34 included in the head chip 3.

The head chip 3 includes M piezoelectric elements 34. M is a natural number of 1 or greater. Hereinafter, an m-th piezoelectric element 34 among the M piezoelectric elements 34 may be referred to as a piezoelectric element 34[m]. m is a natural number satisfying “1<m≤M”. In addition, in the following description, when a component, a signal, or the like of the liquid ejecting head 20 corresponds to the piezoelectric element 34[m], a suffix m may be given to a reference sign representing the component, the signal, or the like.

As illustrated in FIG. 2, the control unit 21 includes a controller 51, a storage section 52, a drive signal generator 54, and a detector 50.

The controller 51 has a function of controlling operations of the sections of the liquid ejecting apparatus 100 and a function of processing various types of data. The controller 51 includes, for example, a processor such as one or more central processing units (CPUs). The controller 51 may include a programmable logic device such as a field-programmable gate array (FPGA) instead of or in addition to the one or more CPUs. In addition, when the controller 51 includes a plurality of processors, the plurality of processors may be mounted on different substrates or the like.

The storage section 52 stores various programs to be executed by the controller 51 and various types of data such as the print data Img to be processed by the controller 51. The storage section 52 includes, for example, either one or both of a semiconductor memory that is a volatile memory such as a random-access memory (RAM) and a semiconductor memory that is a nonvolatile memory such as a read-only memory (ROM), an electrically erasable programmable read-only memory (EEPROM), or a programmable ROM (PROM). The print data Img is supplied from an external apparatus 200 such as a personal computer or a digital camera. The storage section 52 may be configured as a portion of the controller 51.

The drive signal generator 54 includes a circuit that generates a drive signal Com for driving each of the piezoelectric elements 34. Examples of the drive signal Com include a first drive signal ComB, a second drive signal VBS, and a third drive signal ComA, which will be described later. Each of the first drive signal ComB and the third drive signal ComA includes an element that changes in electrical potential over a predetermined electrical potential difference. The first drive signal ComB is a signal related to detection of residual vibration of each of the piezoelectric elements 34. The residual vibration is vibration remaining in ink present in a pressure chamber C1 when the volume of the pressure chamber C1 is changed by the driving of the piezoelectric element 34. The third drive signal ComA is a signal related to ink ejection. The second drive signal VBS includes an element that maintains a fixed electrical potential.

The drive signal generator 54 includes, for example, a DA conversion circuit and an amplifying circuit. The drive signal generator 54 causes the DA conversion circuit to convert a waveform specifying signal dCom into an analog signal, causes the amplifying circuit to amplify the analog signal, and outputs the amplified analog signal. A signal of a waveform that is included in a waveform included in the first drive signal ComB or the third drive signal ComA and is to be actually supplied to each of the piezoelectric elements 34 is the supply drive signal Vin described above. The waveform specifying signal dCom is a digital signal for defining each waveform and each electrical potential of the drive signal Com.

The controller 51 controls operations of the sections of the liquid ejecting apparatus 100 by executing a program stored in the storage section 52. The controller 51 generates control signals Sk1 and Sk2, a print data signal SI, the waveform specifying signal dCom, a latch signal LAT, a change signal CH, a period specifying signal Ts, and a clock signal CLK by executing the program, as signals for controlling operations of the sections of the liquid ejecting apparatus 100.

The control signal Sk2 is a signal for controlling the driving of the transport mechanism 22. The control signal Sk1 is a signal for controlling the driving of the moving mechanism 23. The print data signal SI is a digital signal for specifying an operation state of each of the piezoelectric elements 34. The latch signal LAT, the change signal CH, and the period specifying signal Ts are timing signals that are used together with the print data signal SI to define a timing when the ink is ejected from each of the nozzles of the head chip 3. These timing signals are generated based on, for example, output of an encoder that detects the position of the carriage 231 described above.

### A3: Specific Structure of Head Chip 3

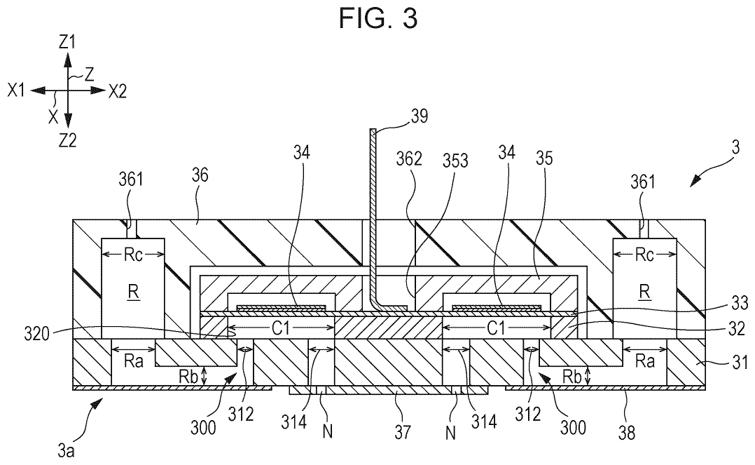

FIG. 3 is a sectional view for explaining a configuration of the head chip 3 illustrated in FIG. 2. The Z axis is an axial line extending along a direction in which the ink is ejected by the head chip 3. A view from the Z1 direction or from the Z2 direction is referred to as a “plan view”.

Although not illustrated, the head chip 3 includes the plurality of nozzles N arrayed along the Y axis. The plurality of nozzles N are divided into two nozzle rows of nozzles N arranged at an interval along the X axis. Each of the two nozzle rows is a group of a plurality of nozzles N linearly arrayed along the Y axis. The head chip 3 has a structure in which elements for the nozzles N in one of the two nozzle rows and elements for the nozzles N in the other of the two nozzle rows are arranged substantially symmetrically with respect to a plane. The following description focuses on the elements for one of the two nozzle rows, and the description of the elements for the other of the two nozzle rows will be omitted as appropriate.

As illustrated in FIG. 3, the head chip 3 includes a flow path structure 3a, the plurality of piezoelectric elements 34, a sealing substrate 35, a housing 36, and a wiring substrate 39.

The flow path structure 3a is a structure in which a flow path for supplying the ink to each of the plurality of nozzles N is formed. The flow path structure 3a includes a communication plate 31, a pressure chamber substrate 32, a vibration plate 33, a nozzle substrate 37, and a vibration absorbing body 38.

Each of the members that form the flow path structure 3a is an elongated plate-shaped member extending along the Y axis. The pressure chamber substrate 32 and the housing 36 are disposed on a surface of the communication plate 31 in the Z1 direction. The nozzle substrate 37 and the vibration absorbing body 38 are disposed on a surface of the communication plate 31 in the Z2 direction. For example, the members are fixed to each other by an adhesive.

The nozzle substrate 37 is a plate-shaped member in which the plurality of nozzles N are formed. Each of the plurality of nozzles N is a circular through-hole from which the ink is ejected. The nozzle substrate 37 is manufactured by, for example, processing a silicon (Si) single-crystal substrate using semiconductor manufacturing techniques such as photolithography and etching.

In the communication plate 31, a plurality of narrow portions 312, a plurality of communication flow paths 314, a communication space Ra, and a common flow path Rb are formed. Each of the narrow portions 312 and the communication flow paths 314 is a through-hole extending in the Z2 direction and formed for a respective one of the nozzles N. The communication flow paths 314 overlap the nozzles N in plan view. The communication space Ra is an opening formed in an elongated shape extending along the Y axis. The common flow path Rb extends along the Y axis. The common flow path Rb communicates with the communication space Ra and overlaps the communication space Ra in plan view. The common flow path Rb communicates with the plurality of narrow portions 312. In addition, the communication space Ra allows the common flow path Rb to communicate with a flow path located outside the head chip 3 via a space Rc, which will be described later.

In the pressure chamber substrate 32, a plurality of pressure chambers C1 are formed. The pressure chambers C1 are spaces located between the communication plate 31 and the vibration plate 33 and formed by wall surfaces 320 of the pressure chamber substrate 32. The pressure chambers C1 are formed for the respective nozzles N. The pressure chambers C1 are elongated spaces extending in the X1 direction. The plurality of pressure chambers C1 are arrayed along the Y axis. One ends of the pressure chambers C1 in the X1 direction communicate with the nozzles N via the communication flow paths 314. The other ends of the pressure chambers C1 in the X2 direction communicate with the narrow portions 312. The cross-sectional area of each of the narrow portions 312 is less than the cross-sectional area of each of the pressure chambers C1. In addition, the pressure chambers C1, the nozzles N, the communication flow paths 314, and the narrow portions 312 form individual flow paths 300 for the respective nozzles N.

Each of the communication plate 31 and the pressure chamber substrate 32 is manufactured by, for example, processing a semiconductor substrate such as a silicon single-crystal substrate.

The vibration plate 33 that is elastically deformable is disposed at upper portions of the pressure chambers C1. The vibration plate 33 is stacked on the pressure chamber substrate 32 and is in contact with a surface of the pressure chamber substrate 32 opposite to a surface of the pressure chamber substrate 32 on which the communication plate 31 is disposed. The vibration plate 33 is a plate-shaped member formed in an elongated rectangular shape extending along the Y axis in plan view. A thickness direction of the vibration plate 33 is parallel to the Z2 direction. The pressure chambers C1 communicate with the communication flow paths 314 and the narrow portions 312. Therefore, the pressure chambers C1 communicate with the nozzles N via the communication flow paths 314 and communicate with the communication space Ra via the narrow portions 312. Although FIG. 3 illustrates the pressure chamber substrate 32 and the vibration plate 33 like different substrates for ease of explanation, the pressure chamber substrate 32 and the vibration plate 33 are actually stacked on one silicon substrate.

The piezoelectric elements 34 for the respective pressure chambers C1 are formed on a surface of the vibration plate 33 opposite to a surface of the vibration plate 33 on the pressure chamber C1 side. Each of the piezoelectric elements 34 has an elongated shape extending along the X axis in plan view. The piezoelectric elements 34 are drive elements that are driven when a drive signal is applied to the piezoelectric elements 34. Each of the piezoelectric elements 34 includes two electrodes and a piezoelectric body disposed between the two electrodes. The piezoelectric elements 34 cause pressure applied to the ink in the pressure chambers C1 to fluctuate and thereby cause the ink in the pressure chambers C1 to be ejected from the nozzles N. The piezoelectric elements 34 deform to vibrate the vibration plate 33 when the drive signal Com is supplied to the piezoelectric elements 34. The vibration causes the pressure chambers C1 to expand and contract and thereby causes the pressure applied to the ink in the pressure chambers C1 to fluctuate.

The housing 36 is a case for storing the ink to be supplied to the plurality of pressure chambers C1 and is formed by injecting a resin material into a mold. The space Rc and a supply port 361 are formed in the housing 36. The supply port 361 is a conduit to which the ink is supplied from the liquid container 12. The supply port 361 communicates with the space Rc. The space Rc of the housing 36 and the communication space Ra of the communication plate 31 communicate with each other. The communication space Ra, the common flow path Rb, and the space Rc, which are described above, form a common space R for the plurality of nozzles N. The common space R functions as a liquid reservoir for storing the ink to be supplied to the plurality of pressure chambers C1. The ink stored in the common space R flows into the narrow portions 312 and is supplied and filled into the plurality of pressure chambers C1 in parallel.

The vibration absorbing body 38 is a flexible film forming a wall surface of the communication space Ra and reduces a fluctuation in the pressure applied to the ink in the common space R. The vibration absorbing body 38 is, for example, a layered structure including an ink-resistant resin film, a stainless steel (SUS) member that holds the resin film and has spring properties, and a fixed plate that protects the resin film and the SUS member.

The sealing substrate 35 is a structure that protects the plurality of piezoelectric elements 34 and reinforces the mechanical strength of the pressure chamber substrate 32 and the mechanical strength of the vibration plate 33. The sealing substrate 35 is fixed to the surface of the vibration plate 33 by, for example, an adhesive. The plurality of piezoelectric elements 34 are stored in recessed portions of the sealing substrate 35. The recessed portions are formed in a surface of the sealing substrate 35 facing the vibration plate 33. In addition, the wiring substrate 39 is inserted in a through-hole 362 of the housing 36 and a through-hole 353 of the sealing substrate 35. The wiring substrate 39 is bonded to the surface of the vibration plate 33. The wiring substrate 39 is a mounting component on which a plurality of wiring lines for electrically coupling the control unit 21 to the head chip 3 are formed. As the wiring substrate 39, for example, a tape carrier package (TCP), a flexible printed circuit (FPC), or the like is used. The drive signal Com for driving each of the piezoelectric elements 34 described above is supplied to each of the piezoelectric elements 34 from the wiring substrate 39.

In the head chip 3, when the piezoelectric elements 34 are energized to contract, the vibration plate 33 is bent and curved such that the volumes of the pressure chambers C1 decrease, the pressure in the pressure chambers C1 increases, and ink droplets are ejected from the nozzles N. In this case, the pressure is transmitted from the pressure chambers C1 toward the narrow portions 312, and the ink also flows into the common flow path Rb through the narrow portions 312. After the ejection of the ink, the piezoelectric elements 34 are restored to the original positions. In this case, the ink in a region from the nozzles N to the common path Rb vibrates. Then, menisci in the nozzles N are restored and concurrently the ink is supplied from the narrow portions 312. By the above-described series of operations, the ink is ejected from the nozzles N.

### A4. Configuration of Drive Controller 30

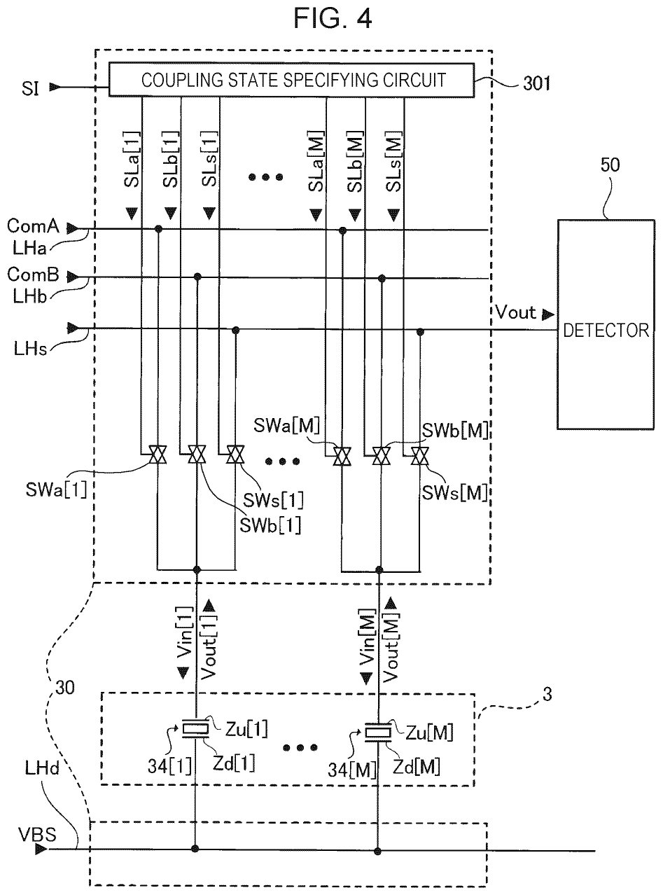

FIG. 4 is a diagram illustrating an example of a configuration of the drive controller 30 illustrated in FIG. 2. The drive controller 30 supplies the drive signal Com as the supply drive signal Vin to the piezoelectric elements 34. The piezoelectric element 34[m] includes a first electrode Zu[m] and a second electrode Zd[m] as two electrodes.

Examples of the drive signal Com include the first drive signal ComB, the second drive signal VBS, and the third drive signal ComA. The first drive signal ComB is a signal related to generation of a residual vibration signal. The third drive signal ComA is a signal related to ejection.

Wiring lines LHa, LHb, LHs, and LHd are coupled to the drive controller 30. The wiring line LHa is a signal line through which the third drive signal ComA is transmitted. The wiring line LHb is a signal line through which the first drive signal ComB is transmitted. The wiring line LHs is a signal line through which the residual vibration signal Vout is transmitted. The wiring line LHs is coupled to the detector 50. The wiring line LHd is a feed line through which the second drive signal VBS is supplied.

The drive controller 30 includes a plurality of switches SW and a coupling state specifying circuit 301 that specifies coupling states of the plurality of switches SW. The plurality of switches SW include M switches SWa (SWa[1] to SWa[M]), M switches SWb (SWb[1] to SWb[M]), and M SWs (SWs[1] to SWs[M]). The switches SW are, for example, transmission gates.

The switch SWa[m] is a switch that switches between conduction (ON) and non-conduction (OFF) between the wiring line LHa through which the third drive signal ComA is transmitted and the piezoelectric element 34[m]. The switch SWb[m] is a switch that switches between conduction (ON) and non-conduction (OFF) between the wiring line LHb through which the first drive signal ComB is transmitted and the piezoelectric element 34[m]. The switch SWs[m] is a switch that switches between conduction (ON) and non-conduction (OFF) between the wiring line LHs through which the residual vibration signal Vout is transmitted and the piezoelectric element 34[m].

The coupling state specifying circuit 301 generates, based on the print data signal SI, a coupling state specifying signal SL that specifies ON or OFF of each of the switches SW. Examples of the coupling state specifying signal SL include coupling state specifying signals SLa[m], SLb[m], and SLs[m].

The coupling state specifying signal SLa[m] is a signal that specifies ON or OFF of the switch SWa[m]. The switch SWa[m] is in an ON state when the coupling state specifying signal SLa[m] is at a high level. The switch SWa[m] is in an OFF state when the coupling state specifying signal SLa[m] is at a low level. The drive controller 30 switches on and off the switch SWa[m] to switch whether or not to supply a portion or all of a waveform included in the third drive signal ComA as the supply drive signal Vin to the first electrode Zu[m] of the piezoelectric element 34[m].

The coupling state specifying signal SLb[m] is a signal that specifies ON or OFF of the switch SWb[m]. The switch SWb[m] is in an ON state when the coupling state specifying signal SLb[m] is at a high level. The switch SWb[m] is in an OFF state when the coupling state specifying signal SLb[m] is at a low level. The drive controller 30 switches on and off the switch SWb[m] to switch whether or not to supply a portion or all of a waveform included in the first drive signal ComB as the supply drive signal Vin to the first electrode Zu[m] of the piezoelectric element 34[m].

The coupling state specifying signal SLs[m] is a signal that specifies ON or OFF of the switch SWs[m]. The switch SWs[m] is in an ON state when the coupling state specifying signal SLs[m] is at a high level. The switch SWs[m] is in an OFF state when the coupling state specifying signal SLs[m] is at a low level. The drive controller 30 switches on and off the switch SWs[m] to switch between a state in which it is possible to detect the residual vibration signal Vout from the piezoelectric element 34[m] and a state in which it is not possible to detect the residual vibration signal Vout from the piezoelectric element 34[m].

A period of time when the switch SWa[m] is ON, a period of time when the switch SWb[m] is ON, and a period of time when the switch SWs[m] is ON do not overlap each other. That is, the switch SWa[m], the switch SWb[m], and the switch SWs[m] are exclusively ON. In addition, the wiring line LHd is electrically coupled to the second electrode Zd[m] of the piezoelectric element 34[m], and the second drive signal VBS is supplied to the second electrode Zd[m] of the piezoelectric element 34[m].

For example, in a state in which the second drive signal VBS is supplied to the second electrode Zd[m], the switch SWa[m] is turned on to supply the third drive signal ComA to the first electrode Zu[m] of the piezoelectric element 34[m]. By supplying the above-described signals, a voltage corresponding to the difference in electrical potential between the first electrode Zu[m] and the second electrode Zd[m] is applied to the piezoelectric element 34[m]. As a result, the piezoelectric element 34[m] is driven to cause the pressure in the pressure chamber C1 to fluctuate and thereby cause the ink to be ejected from the nozzle N.

In addition, for example, in a state in which the second drive signal VBS is supplied to the second electrode Zd[m], the switch SWb[m] is turned on to supply the first drive signal ComB to the first electrode Zu[m] of the piezoelectric element 34[m]. By supplying the above-described signals, a voltage corresponding to the difference in electrical potential between the first electrode Zu[m] and the second electrode Zd[m] is applied to the piezoelectric element 34[m]. As a result, the piezoelectric element 34[m] causes the pressure in the pressure chamber C1 to fluctuate to the extent that the ink is not ejected from the nozzle N. In addition, for example, when the switch SWs[m] is turned on immediately after the switch SWb[m] is turned on, the residual vibration signal Vout is detected by the detector 50.

### A5: Waveforms Included in Drive Signal Com

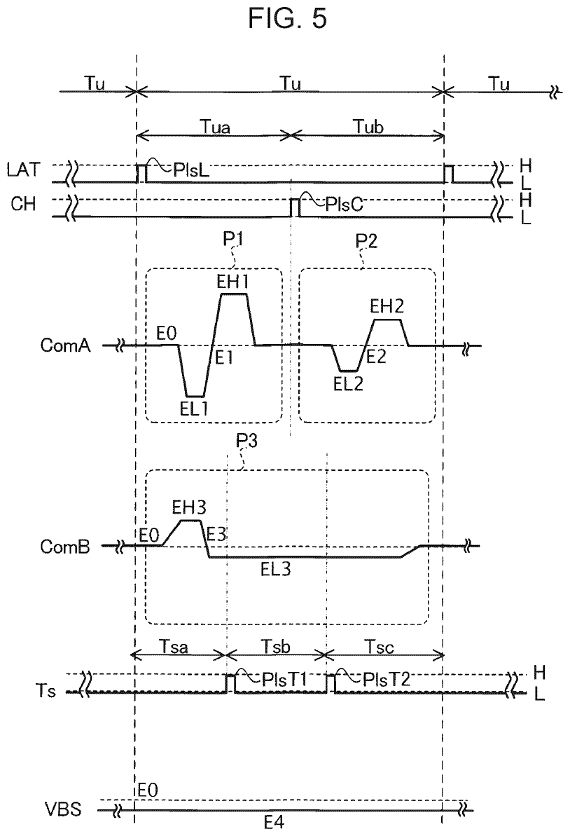

FIG. 5 is a diagram for explaining waveforms included in the drive signal Com according to the first embodiment. As illustrated in FIG. 5, the latch signal LAT includes a pulse PlsL for defining a cycle Tu that is repeated. The cycle Tu corresponds to a printing cycle in which dots of the ink from the nozzles N are formed on the medium 11. The cycle Tu is, for example, defined as a period of time from the rising edge of the pulse PlsL to the rising edge of the next pulse PlsL.

The change signal CH includes a pulse PlsC for dividing the cycle Tu into a preceding control period Tua and a succeeding control period Tub. The control period Tua is, for example, a period of time from the rising edge of the pulse PlsL to the rising edge of the pulse PlsC. The control period Tub is, for example, a period of time from the rising edge of the pulse PlsC to the rising edge of the next pulse PlsL. In addition, the period specifying signal Ts includes pulses PlsT1 and PlsT2 for dividing the cycle Tu into control periods Tsa, Tsb, and Tsc. The control period Tsa is a period of time from the rising edge of the pulse PlsL to the rising edge of the pulse PlsT1. The control period Tsb is a period of time from the rising edge of the pulse PlsT1 to the rising edge of the pulse PlsT2. The control period Tsc is a period of time from the rising edge of the pulse PlsT2 to the rising edge of the next pulse PlsL.

The third drive signal ComA includes an electrical potential pulse related to ink ejection. Specifically, the third drive signal ComA includes a middle-dot ejection waveform P1 in the control period Tua and a small-dot ejection waveform P2 in the control period Tub.

The ejection waveform P1 is a waveform of an electrical potential that decreases from a reference electrical potential E0 to a lowest electrical potential EL1 lower than the reference electrical potential E0, increases to a highest electrical potential EH1 higher than the reference electrical potential E0 after changing according to an ejection electrical potential-changing element E1, and returns to the reference electrical potential E0. In the example illustrated in FIG. 5, the ejection electrical potential-changing element E1 is a rising edge from the lowest electrical potential EL1 toward the highest electrical potential EH1. The ejection electrical potential-changing element E1 is an element that changes the volume of the pressure chamber C1 to cause the pressure applied to the ink in the pressure chamber C1 to fluctuate to the extent that an ink droplet is ejected from the nozzle N communicating with the pressure chamber C1.

The ejection waveform P2 is a waveform of an electrical potential that decreases from the reference electrical potential E0 to a lowest electrical potential EL2 lower than the reference electrical potential E0, increases to a highest electrical potential EH2 higher than the reference electrical potential E0 after changing according to an ejection electrical potential-changing element E2, and returns to the reference electrical potential E0. In the example illustrated in FIG. 5, the ejection electrical potential-changing element E2 is a rising edge from the lowest electrical potential EL2 toward the highest electrical potential EH2. The ejection electrical potential-changing element E2 is an element that changes the volume of the pressure chamber C1 to cause the pressure applied to the ink in the pressure chamber C1 to fluctuate to the extent that an ink droplet is ejected from the nozzle N communicating with the pressure chamber C1.

The difference between the highest electrical potential EH1 and the lowest electrical potential EL1 of the ejection waveform P1 is greater than the difference between the highest electrical potential EH2 and the lowest electrical potential EL2 of the ejection waveform P2. In each of the ejection waveform P1 and the ejection waveform P2, the electrical potential at the start time and the electrical potential at the end time are set to the reference electrical potential E0.

In the cycle Tu, a large dot, a medium dot, and a small dot that have different sizes can be ejected from the nozzle N by appropriately combining the ejection waveforms P1 and P2. That is, the drive controller 30 switches on and off the above-described switch SWa[m] in the control periods Tua and Tub to supply portions or all of the ejection waveforms P1 and P2 as the supply drive signal Vin to the piezoelectric element 34[m] in each cycle Tu. As a result, a large dot, a medium dot, and a small dot that have different sizes can be dropped onto the medium 11 in each cycle Tu.

The first drive signal ComB includes an electrical potential pulse for detecting residual vibration. In the example illustrated in FIG. 5, the first drive signal ComB includes a detection waveform P3 in the cycle Tu. Specifically, the detection waveform P3 is an electrical potential pulse for driving the piezoelectric element 34 to cause the pressure in the pressure chamber C1 to fluctuate to the extent that the ink is not ejected from the nozzle N. The difference between a highest electrical potential EH3 and a lowest electrical potential EL3 of the detection waveform P3 is less than the difference between the highest electrical potential EH2 and the lowest electrical potential EL2 of the ejection waveform P2. In the detection waveform P3, the electrical potential at the start time and the electrical potential at the end time are set to the reference electrical potential E0.

The detection waveform P3 is a waveform of an electrical potential that increases from the reference electrical potential E0 to the highest electrical potential EH3 higher than the reference electrical potential E0, decreases to the lowest electrical potential EL3 lower than the reference electrical potential E0 after changing according to an electrical potential-changing element E3, and returns to the reference electrical potential E0. The electrical potential-changing element E3 is an element that changes in electrical potential over a predetermined electrical potential difference from the highest electrical potential EH3 as a “starting electrical potential” to the lowest electrical potential EL3 as an “ending electrical potential”. In the example illustrated in FIG. 5, the electrical potential-changing element E3 is a falling edge from the highest electrical potential EH3 toward the lowest electrical potential EL3.

The coupling state specifying circuit 301 sets the coupling state specifying signal SLb[m] to a high level in the control periods Tsa and Tsc and to a low level in the control period Tsb. In the control period Tsa, the piezoelectric element 34[m] is deformed by the electrical potential-changing element E3 to the extent that the ink is not ejected from the nozzle N. As a result, the piezoelectric element 34[m] vibrates and the vibration of the ink in the pressure chamber C1 due to the vibration of the piezoelectric element 34[m] remains in the control period Tsb. Then, in the control period Tsb, the piezoelectric element 34[m] has an electrical potential according to electromotive force of the piezoelectric element 34[m] caused by the residual vibration in the control period Tsa. The electrical potential is detected as the residual vibration signal Vout in the control period Tsb.

The second drive signal VBS is an offset electrical potential. The second drive signal VBS includes an electrical potential-maintained element E4 that maintains a fixed electrical potential.

### A6: Waveform of Residual Vibration Signal Vout

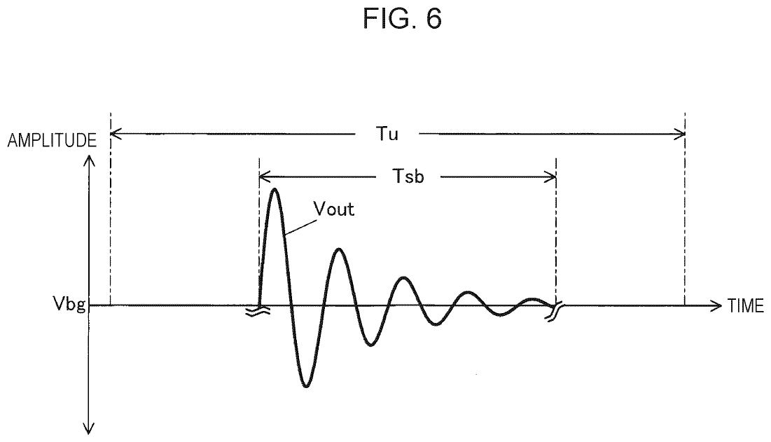

FIG. 6 is a diagram illustrating the residual vibration signal Vout. As illustrated in FIG. 6, the residual vibration signal Vout is detected in the control period Tsb. The residual vibration has a natural vibration frequency determined based on the shape of the nozzle N, the shape of the individual flow path, the weight of the ink in the flow path of the head chip 3, the viscosity of the ink, and the like. When an ejection abnormality occurs, the natural vibration frequency and amplitude of the residual vibration change compared with those in a normal state. The ejection abnormality occurs, for example, when the piezoelectric element 34 fails and is not able to deform, when an air bubble is mixed into the individual flow path, when foreign matter adheres to a portion in the vicinity of the nozzle N, when the ink is thickened, or the like. By detecting the residual vibration, it is possible to detect the ejection abnormality.

### A7: Estimation of Ejection Performance of Liquid Ejecting Apparatus 100

In addition to the above-described abnormality, although it is not the ejection abnormality, when a period of time when the liquid ejecting apparatus 100 performs printing is long, a color difference may occur and the printing quality may decrease.

In the liquid ejecting apparatus 100, the drive signal Com according to amounts of liquid to be ejected from the nozzles N is set based on the piezoelectric properties of the piezoelectric bodies of the piezoelectric elements 34. The piezoelectric properties of the piezoelectric bodies of the piezoelectric elements 34 change as a period of time when the liquid ejecting apparatus 100 performs printing increases. That is, the piezoelectric properties of the piezoelectric bodies of the piezoelectric elements 34 change when the piezoelectric elements 34 are continuously driven. Therefore, when the drive signal Com based on the piezoelectric properties set during the manufacture of the liquid ejecting apparatus 100 is used, and the piezoelectric elements 34 are continuously driven, the amounts of liquid ejected from the nozzles N may gradually change. As a result, although it is not the above-described ejection abnormality, a decrease in the ejection performance, such as a color difference, may occur.

When the piezoelectric elements 34 are continuously driven, the hysteresis properties of the piezoelectric elements 34 change. Particularly, a coercive voltage of each of the piezoelectric elements 34 changes. A change in the piezoelectric properties of the piezoelectric elements 34 can be estimated by capturing a change in the coercive voltage.

In the detection of the residual vibration described above, when the voltage applied to the piezoelectric body of the piezoelectric element 34 is changed to a voltage close to the coercive voltage by changing one or both of the first drive signal ComB and the second drive signal VBS, the piezoelectric effect is lost. Therefore, when the voltage applied to the piezoelectric element 34 is close to the coercive voltage, the residual vibration is not detected. By using the fact that residual vibration is not detected, it is possible to identify the coercive voltage of the piezoelectric element 34[m]. In the present embodiment, the coercive voltage corresponds to a “deformation property” of the piezoelectric element 34.

Specifically, the drive signal generator 54 generates a plurality of pairs of first drive signals ComB to be supplied to the first electrode Zu[m] and second drive signals VBS to be supplied to the second electrode Zd[m]. In the plurality of pairs, differences D between lowest electrical potentials EL3 corresponding to the ending electrical potentials of the electrical potential-changing elements E3 of the first drive signals ComB and electrical potentials maintained in electrical potential-maintained elements E4 of the second drive signals VBS are different from each other. Then, the detector 50 detects residual vibration signals Vout for the respective pairs and identifies a deformation property corresponding to the coercive voltage based on the residual vibration signals Vout for the plurality of pairs.

### A8. Method of Driving Liquid Ejecting Apparatus 100

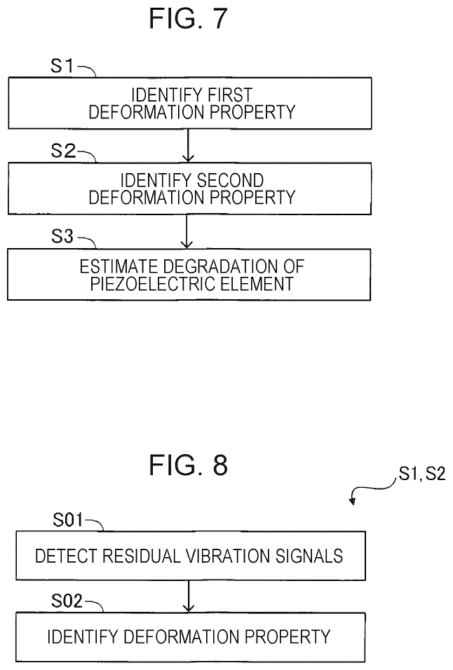

FIG. 7 is a diagram for explaining a method of driving the liquid ejecting apparatus 100 according to the first embodiment. FIG. 8 is a diagram for explaining step S01 and step S02 included in each of first step S1 and second step S2 illustrated in FIG. 7. Methods of driving the liquid ejecting apparatus 100 in order to identify deformation properties of the piezoelectric element 34[m] and a method of driving the liquid ejecting apparatus 100 in order to estimate degradation of the piezoelectric element 34[m] will be described below.

As illustrated in FIG. 7, the method of driving the liquid ejecting apparatus 100 includes first step S1 of identifying a first deformation property at a first timing, second step S2 of identifying a second deformation property at a second timing, and third step S3 of estimating degradation of the piezoelectric element 34[m]. The second timing is a timing after a predetermined period of time from the first timing.

As illustrated in FIG. 8, each of first step S1 and second step S2 includes step S01 of detecting residual vibration signals Vout and step S02 of identifying a deformation property of the piezoelectric element 34[m]. The deformation property of the piezoelectric element 34[m] identified at the first timing in first step S1 is the first deformation property, while the deformation property of the piezoelectric element 34[m] identified at the second timing in second step S2 is the second deformation property. The method of driving the liquid ejecting apparatus 100 in order to identify the first deformation property and the method of driving the liquid ejecting apparatus 100 in order to identify the second deformation property are the same except that the timings when the first and second deformation properties are identified are different.

In step S01, every time the drive controller 30 supplies, to the piezoelectric element 34[m], each of a plurality of pairs of first drive signals ComB and second drive signals VBS, the detector 50 detects a residual vibration signal Vout corresponding to each of the pairs. In this case, in the pairs, either the first drive signals ComB or the second drive signals VBS are different from each other, or the first drive signals ComB are different and the second drive signals VBS are different from each other. The plurality of pairs of the first drive signals ComB and the second drive signals VBS are generated by the drive signal generator 54.

In step S02, the detector 50 identifies the deformation property of the piezoelectric element 34[m] based on the residual vibration signals Vout corresponding to the respective pairs detected in step S01.

### A8-1. Step S01

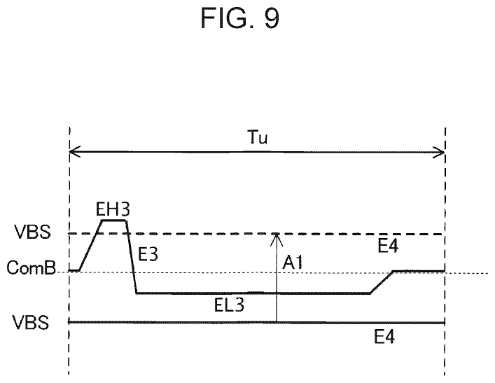

FIG. 9 is a diagram for explaining the plurality of pairs of the first drive signals ComB and the second drive signals VBS to be supplied to the piezoelectric element 34[m] in step S01. As illustrated in FIG. 9, in step S01, the drive signal generator 54 generates the plurality of pairs of the first drive signals ComB and the second drive signals VBS by changing the electrical potential of the electrical potential-maintained element E4 of the second drive signal VBS. For example, as indicated by an arrow A1, the plurality of pairs are generated by increasing the electrical potential from the second drive signal VBS indicated by a solid line to the second drive signal VBS indicated by a broken line for each of the pairs of the first drive signals ComB and the second drive signals VBS. In the present embodiment, in the generation of the plurality of pairs, the electrical potential and the waveform of the first drive signal ComB are not changed. Thus, in the plurality of pairs, the electrical potentials of the first drive signals ComB are equal to each other, and the waveforms of the first drive signals ComB are equal to each other. Therefore, differences D in electrical potential between the first drive signals ComB and the second drive signals VBS are different for the pairs of the first drive signals ComB and the second drive signals VBS.

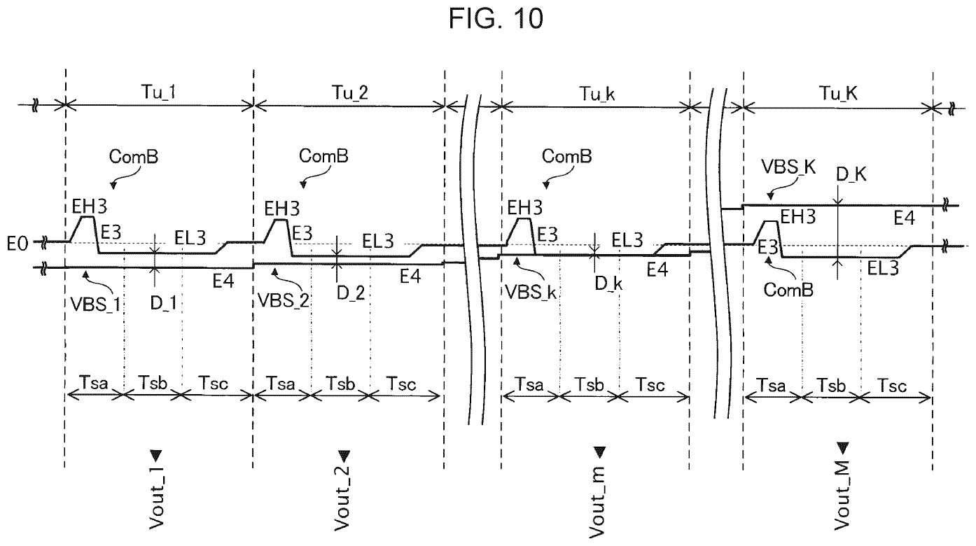

FIG. 10 is a diagram illustrating changes over time in order to explain step S01. Step S01 for identifying a deformation property will be exemplified below with reference to FIG. 10. In the following example, the drive signal generator 54 generates K pairs of first drive signals ComB and second drive signals VBS. K is a natural number of 2 or more. The K pairs are also referred to as the first to K-th pairs. In the following description, a k-th pair among the K pairs may be referred to as a k-th pair. In addition, in the following description, 1 to K that are suffixes may be given to elements or signals that correspond to the first to K-th pairs.

In the example illustrated in FIG. 10, K cycles Tu are continuous. In the K cycles Tu, the drive controller 30 supplies the K pairs of the first drive signals ComB and the second drive signals VBS to the piezoelectric element 34[m]. In addition, in the K cycles Tu, the detector 50 detects K residual vibration signals Vout. In the example illustrated in FIG. 10, the K cycles Tu are continuous but may not be continuous.

As illustrated in FIG. 10, in a cycle Tu_1, the first pair of the first drive signal ComB and the second drive signal VBS_1 is supplied to the piezoelectric element 34[m]. Specifically, the first drive signal ComB is supplied to the first electrode Zu[m], and the second drive signal VBS_1 is supplied to the second electrode Zd[m]. Therefore, in a control period Tsa in the cycle Tu_1, the piezoelectric element 34[m] deforms from a deformation state corresponding to the difference between the reference electrical potential E0 and the electrical potential of the electrical potential-maintained element E4 to a deformation state corresponding to the difference between the highest electrical potential EH3 and the electrical potential of the electrical potential-maintained element E4, and deforms to a deformation state corresponding to the difference D_1 between the lowest electrical potential EL3 and the electrical potential of the electrical potential-maintained element E4. In addition, in a control period Tsb in the cycle Tu_1, the piezoelectric element 34[m] in the deformation state corresponding to the difference D_1 between the electrical potentials has an electrical potential according to electromotive force by the piezoelectric effect of the piezoelectric element 34[m] caused by residual vibration due to a fluctuation in the pressure applied to the liquid in the pressure chamber C1 in the control period Tsa. The electrical potential according to the electromotive force of the piezoelectric element 34[m] is detected by the detector 50 as a residual vibration signal Vout_1

In a cycle Tu_2 following the cycle Tu_1, the second pair of the first drive signal ComB and the second drive signal VBS_2 is supplied to the piezoelectric element 34[m]. Specifically, the first drive signal ComB is supplied to the first electrode Zu[m], and the second drive signal VBS_2 is supplied to the second electrode Zd[m]. Therefore, in a control period Tsa in the cycle Tu_2, the piezoelectric element 34[m] deforms from a deformation state corresponding to the difference between the reference electrical potential E0 and the electrical potential of the electrical potential-maintained element E4 to a deformation state corresponding to the difference between the highest electrical potential EH3 and the electrical potential of the electrical potential-maintained element E4, and is maintained in a deformation state corresponding to the difference D_2 between the lowest electrical potential EL3 and the electrical potential of the electrical potential-maintained element E4. In addition, in a control period Tsb in the cycle Tu_2, the piezoelectric element 34[m] in the deformation state corresponding to the difference D_2 between the electrical potentials has an electrical potential according to electromotive force by the piezoelectric effect of the piezoelectric element 34[m] caused by residual vibration due to a fluctuation in the pressure applied to the liquid in the pressure chamber C1 in the control period Tsa. The electrical potential according to the electromotive force of the piezoelectric element 34[m] is detected by the detector 50 as a residual vibration signal Vout_2.

The second pair of the first drive signal ComB and the second drive signal VBS_2 is different from the first pair of the first drive signal ComB and the second drive signal VBS_1. Specifically, the electrical potential of the electrical potential-maintained element E4 of the second drive signal VBS_2 is different from the electrical potential of the electrical potential-maintained element E4 of the second drive signal VBS_1. Therefore, the difference between the reference electrical potential E0 and the electrical potential of the electrical potential-maintained element E4, the difference between the highest electrical potential EH3 and the electrical potential of the electrical potential-maintained element E4, and the difference D between the lowest electrical potential EL3 and the electrical potential of the electrical potential-maintained element E4 in the first pair are different from the difference between the reference electrical potential E0 and the electrical potential of the electrical potential-maintained element E4, the difference between the highest electrical potential EH3 and the electrical potential of the electrical potential-maintained element E4, and the difference D between the lowest electrical potential EL3 and the electrical potential of the electrical potential-maintained element E4 in the second pair. That is, the difference D_2 between the electrical potentials is different from the difference D_1 between the electrical potentials, and thus the deformation state of the piezoelectric element 34[m] when the residual vibration signal Vout is detected for the first pair is different from the deformation state of the piezoelectric element 34[m] when the residual vibration signal Vout is detected for the second pair. In the example illustrated in FIG. 9, the electrical potential of the electrical potential-maintained element E4 of the second drive signal VBS_2 is higher than the electrical potential of the electrical potential-maintained element E4 of the first drive signal VBS_1, and the difference D_2 between the electrical potentials is less than the difference D_1 between the electrical potentials.

In a cycle Tu_k, the k-th pair of the first drive signal ComB and the second drive signal VBS_k is supplied to the piezoelectric element 34[m]. Specifically, the first drive signal ComB is supplied to the first electrode Zu[m], and the second drive signal VBS_k is supplied to the second electrode Zd[m]. Therefore, in a control period Tsa in the cycle Tu_k, the piezoelectric element 34[m] deforms from a deformation state corresponding to the difference between the reference electrical potential E0 and the electrical potential of the electrical potential-maintained element E4 to a deformation state corresponding to the difference between the highest electrical potential EH3 and the electrical potential of the electrical potential-maintained element E4, and deforms to a deformation state corresponding to the difference D_k between the lowest electrical potential EL3 and the electrical potential of the electrical potential-maintained element E4. In addition, in a control period Tsb in the cycle Tu_k, the piezoelectric element 34[m] in the deformation state corresponding to the difference D_k between the electrical potentials has an electrical potential according to electromotive force by the piezoelectric effect of the piezoelectric element 34[m] caused by residual vibration due to a fluctuation in the pressure applied to the liquid in the pressure chamber C1 in the control period Tsa. The electrical potential according to the electromotive force of the piezoelectric element 34[m] is detected by the detector 50 as a residual vibration signal Vout_k.

The k-th pair of the first drive signal ComB and the second drive signal VBS_k is different from the pairs preceding and succeeding the k-th pairs. Specifically, the electrical potential of the electrical potential-maintained element E4 of the second drive signal VBS_k is different from the electrical potential of the electrical potential-maintained element E4 of each of the pairs preceding and succeeding the k-th pair. Therefore, the difference D_k between the electrical potentials is different from each of the differences D between the electrical potentials of the pairs preceding and succeeding the k-th pair. The absolute value of the difference D_k between the electrical potentials illustrated in FIG. 9 is a positive value that is the largest among the absolute values of the differences D between the electrical potentials of the plurality of pairs in the example.

In the present embodiment, each of the differences D between the electrical potentials can be a value obtained by subtracting the electrical potential of the electrical potential-maintained element E4 from the lowest electrical potential EL3. Therefore, in the present embodiment, when the electrical potential of the electrical potential-maintained element E4 is lower than the lowest electrical potential EL3, the difference D between the electrical potentials is a positive value. In the present embodiment, when the electrical potential of the electrical potential-maintained element E4 is higher than the lowest electrical potential EL3, the difference D between the electrical potentials is a negative value.

In a cycle Tu_K, the K-th pair of the first drive signal ComB and the second drive signal VBS_K is supplied to the piezoelectric element 34[m]. Specifically, the first drive signal ComB is supplied to the first electrode Zu[m], and the second drive signal VBS_K is supplied to the second electrode Zd[m]. Therefore, in a control period Tsa in the cycle Tu_K, the piezoelectric element 34[m] deforms from a deformation state corresponding to the difference between the reference electrical potential E0 and the electrical potential of the electrical potential-maintained element E4 to a deformation state corresponding to the difference between the highest electrical potential EH3 and the electrical potential of the electrical potential-maintained element E4, and deforms to a deformation corresponding to the difference D_K between the lowest electrical potential EL3 and the electrical potential of the electrical potential-maintained element E4. In addition, in a control period Tsb in the cycle Tu_K, the piezoelectric element 34[m] in the deformation state corresponding to the difference D_K between the electrical potentials has an electrical potential according to electromotive force by the piezoelectric effect of the piezoelectric element 34[m] caused by residual vibration due to a fluctuation in the pressure applied to the liquid in the pressure chamber C1 in the control period Tsa. The electrical potential according to the electromotive force of the piezoelectric element 34[m] is detected by the detector 50 as a residual vibration signal Vout_K.

The K-th pair of the first drive signal ComB and the second drive signal VBS_K is different from the pairs preceding the K-th pairs. Specifically, the electrical potential of the electrical potential-maintained element E4 of the second drive signal VBS_K is different from the electrical potential of the electrical potential-maintained element E4 of each of the pairs preceding the K-th pair. Therefore, the difference D K between the electrical potentials is different from each of the differences D between the electrical potentials of the pairs preceding the K-th pair.

In the above-described manner, the detector 50 detects the K residual vibration signals Vout.

### A8-2. Step S02

In step S02, the detector 50 identifies the deformation property corresponding to the coercive voltage of the piezoelectric element 34[m] based on the K residual vibration signals Vout. When the difference in electrical potential between the first electrode Zu[m] and the second electrode Zd[m] of the piezoelectric element 34[m] is close to the coercive voltage, the piezoelectric effect is lost. Therefore, as described above, in the detection of the residual vibration signals Vout, when the difference D between the electrical potentials that is a voltage applied to the piezoelectric body of the piezoelectric element 34 is changed and close to the coercive voltage, residual vibration is not detected. By using the fact that residual vibration is not detected, it is possible to identify the deformation property that is the coercive voltage of the piezoelectric element 34.

For example, the deformation property is identified from amplitude states of the residual vibration signals Vout as illustrated in FIG. 6 described above. Specifically, for example, the deformation property is identified based on correlation between the difference D between the electrical potentials and a spectral intensity of a predetermined frequency component obtained from frequency analysis of the K residual vibration signals Vout. An example of the frequency analysis is Fourier transform.

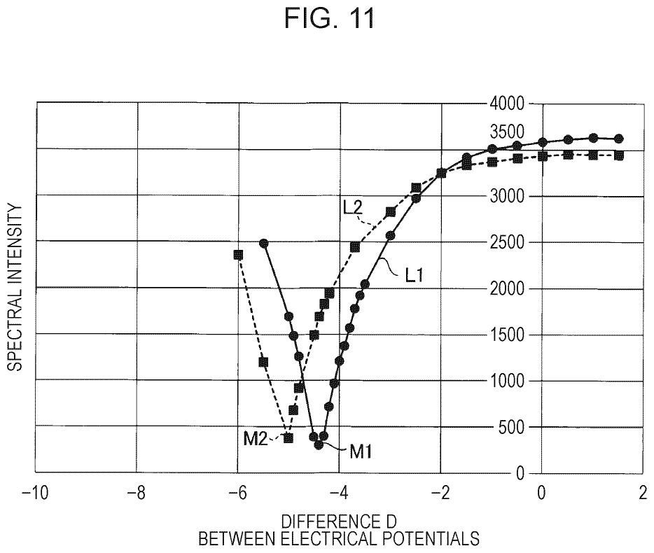

FIG. 11 is a graph illustrating a relationship between the spectral intensity and the difference D between the electrical potentials. In FIG. 11, the horizontal axis indicates the above-described difference D between the electrical potentials, and the vertical axis indicates a spectral intensity of a natural vibration frequency (Tc) of residual vibration as the predetermined frequency component obtained from the frequency analysis. In addition, results obtained at the first timing are indicated by a line segment L1, and results obtained at the second timing are indicated by a line segment L2.

When the difference D between the electrical potentials is changed, the spectral intensity of the natural vibration frequency changes. This correlates with the fact that when the difference in electrical potential between the first electrode Zu[m] and the second electrode Zd[m] of the piezoelectric element 34[m] is changed, the amount of deformation of the piezoelectric element 34[m] that is the amount of distortion of the piezoelectric element 34[m] changes. In addition, when the difference D in electrical potential between the first electrode Zu[m] and the second electrode Zd[m] of the piezoelectric element 34[m] is close to the coercive voltage, residual vibration is not detected and the spectral intensity is the minimum value. Therefore, the difference D between the electrical potentials that causes the spectral intensity to be the minimum value corresponds to the coercive voltage. That is, the difference D between the electrical potentials that corresponds to the minimum value corresponds to the deformation property. Therefore, by performing the frequency analysis to identify the difference D between the electrical potentials that causes the spectral intensity to be the minimum value, the difference D between the electrical potentials can be identified as the coercive voltage, that is, as the deformation property.

As described above, in step S02, the detector 50 identifies the deformation property, which is the coercive voltage of the piezoelectric element 34[m], based on the differences D between the electrical potentials of the K pairs and the frequency analysis of each of the residual vibration signals Vout.

The above-described step S01 and step S02 are performed in each of first step S1 and second step S2.

### A8-3. Step S3

In third step S3, the detector 50 estimates degradation of the piezoelectric element 34[m]. As illustrated in FIG. 11, the line segment L1 obtained at the first timing does not match the line segment L2 obtained at the second timing, and the line segment L2 obtained at the second timing is shifted to the lower electrical potential side, compared with the line segment L1 obtained at the first timing. The difference D between the electrical potentials that corresponds to the minimum value M2 among spectral intensities obtained at the second timing is shifted to the lower electrical potential side, compared with the difference D between the electrical potentials that corresponds to the minimum value M1 among spectral intensities obtained at the first timing. As can be seen from FIG. 11, the difference D between the electrical potentials is shifted over time and thus the deformation property that is the coercive voltage is shifted over time. This is due to the fact that, in a time period from the first timing to the second timing, the hysteresis properties of the piezoelectric element 34[m] change according to a period of time when a voltage is applied to the piezoelectric element 34[m], the magnitude of the voltage applied to the piezoelectric element 34[m], the temperature of the piezoelectric element 34[m], and the like, and the coercive voltage is shifted as a main change. Therefore, it is possible to determine a degree of change in the hysteresis properties of the piezoelectric element 34[m] by detecting an amount by which the coercive voltage is shifted.

In the storage section 52, correlation data of the strength of an electric field (applied voltage) applied to the piezoelectric element 34[m] and the amount of deformation of the piezoelectric element 34[m] according to an amount by which the coercive voltage is shifted is stored. Alternatively, in the storage section 52, correlation data of a target amount of ink to be ejected and a correction amount of the third drive signal ComA according to an amount by which the coercive voltage is shifted is stored.

In addition, a table of a correction amount of the third drive signal ComA according to the coercive voltage of the piezoelectric element 34[m] can be stored in the storage section 52.

The detector 50 obtains a correction value of the third drive signal ComA based on the correlation data stored in the storage section 52 and an amount by which the difference D between the electrical potentials that corresponds to the coercive voltage at the second timing is shifted from the difference D between the electrical potentials that corresponds to the coercive voltage at the first timing. For example, the difference between the first and second deformation properties that corresponds to the amount by which the coercive voltage is shifted is determined as a degree of degradation of the piezoelectric element 34[m] that is an example of a state of change in the deformation property of the piezoelectric element 34[m]. Then, the detector 50 obtains the correction value of the third drive signal ComA according to the degree of degradation based on the correlation data stored in the storage section 52. Based on the result of obtaining the correction value, the controller 51 corrects waveform data corresponding to the third drive signal ComA to generate a waveform specifying signal dCom. The drive signal generator 54 generates, from the corrected waveform specifying signal dCom, the third drive signal ComA related to ejection. Therefore, amounts of ink to be ejected from the nozzle N based on the third drive signal ComA at the second timing and the subsequent timings can be corrected to an amount of ink that is ejected at the first timing. The difference between the first deformation property and the second deformation property corresponds to “property information” including the deformation property.

In addition, for example, the detector 50 obtains the correction amount of the third drive signal ComA according to the coercive voltage based on the table stored in the storage section 52 described above. The controller 51 corrects the waveform data corresponding to the third drive signal ComA to generate the waveform specifying signal dCom by using the correction amount obtained by the detector 50. The drive signal generator 54 generates, from the corrected waveform specifying signal dCom, the third drive signal ComA related to ejection. Therefore, the amount of ink to be ejected from the nozzle N based on the third drive signal ComA can be corrected to an appropriate amount.

According to the method described above, it is possible to identify the deformation properties of the piezoelectric element 34[m] based on a plurality of residual vibration signals Vout detected using a plurality of pairs of first drive signals ComB and second drive signals VBS. In this case, in the pairs, either the first drive signals ComB or the second drive signals VBS are different from each other, or the first drive signals ComB are different from each other and the second drive signals VBS are different from each other. In addition, it is possible to determine a degradation state of the piezoelectric element 34[m] based on a difference between the first deformation property identified at the first timing and the second deformation property identified at the second timing. Since an amount of ink to be ejected can be corrected to an appropriate amount by correcting the third drive signal ComA according to the identified deformation properties of the piezoelectric element 34 and the degree of degradation of the piezoelectric element 34, it is possible to reduce a possibility that a decrease in the ejection performance, such as a color difference, may occur.

The method of driving the liquid ejecting apparatus 100 to identify the first deformation property of the piezoelectric element 34[m] is described above. As described above, the detector 50 detects a residual vibration signal Vout for each of a plurality of pairs in which differences D between electrical potentials are different from each other, and identifies the first deformation property corresponding to the coercive voltage based on the residual vibration signals Vout for the plurality of pairs. That is, the first deformation property is identified based on the residual vibration signals Vout for the plurality of pairs detected by performing step S01 and step S02. The residual vibration signals Vout are signals indicating variations in electromotive force according to variations in the residual pressure applied to the ink in the pressure chamber C1 in the piezoelectric element 34[m] that deforms according to the differences D between the electrical potentials after the electrical potential-changing elements E3 are supplied to the first electrode Zu[m] and the electrical potential-maintained elements E4 are supplied to the second electrode Zd[m].

In this manner, the first deformation property of the piezoelectric element 34[m] can be identified by using the residual vibration signals Vout. The detection of the residual vibration signals Vout is also a function used to detect an ejection abnormality of each of the nozzles N, and an additional measuring device or the like does not need to be included in the liquid ejecting apparatus 100 in order to identify the deformation properties of the piezoelectric element 34[m].

In addition, the third drive signal ComA related to ejection can be appropriately corrected according to the first deformation property identified using the residual vibration signals Vout. In addition, it is possible to estimate degradation of the piezoelectric element 34 by using the first deformation property identified using the residual vibration signals Vout. That is, the durability of the piezoelectric element 34 can be estimated. Thus, by performing, based on the estimated result, correction or the like of an amount of ink to be ejected, it is possible to reduce a possibility that a decrease in the ejection performance, such as a color difference, may occur. Therefore, it is possible to suppress a decrease in the printing quality.

In addition, in the present embodiment, the first deformation property includes the coercive voltage. The coercive voltage indicates a particularly significant change when the piezoelectric element 34 is continuously driven. Further, by identifying the coercive voltage, it is possible to estimate the hysteresis properties of the piezoelectric element 34. Therefore, capturing a change in the coercive voltage is suitable for estimating a change in the hysteresis properties of the piezoelectric element 34, that is, estimating degradation of the piezoelectric element 34.

In the above description, the first deformation property includes the coercive voltage but may include a property of the piezoelectric element 34 other than the coercive voltage. In addition, the second deformation property may be a property other than the coercive voltage.

For example, a slope indicating a change in the spectral intensity with respect to a change in the difference D between the electrical potentials can be used as a deformation property. Specifically, spectral intensities corresponding to at least predetermined two differences D between electrical potentials are detected by the above-described detection method. Information regarding the slope indicating the change in the spectral intensity with respect to the change in the difference D between the electrical potentials is obtained from the detected spectral intensities and the differences D between the electrical potentials. The information regarding the slope indicating the change in the spectral intensity with respect to the change in the difference D between the electrical potentials may be an n-th order functional formula that approximates correlation between the difference D between the electrical potentials and the spectral intensity (n is a natural number of 1 or more). In the storage section 52, a plurality of types of deformation properties according to a degree of degradation of the piezoelectric element 34 obtained by an experiment or the like in advance, and correction amounts of the third drive signal ComA that correspond to the plurality of types of deformation properties are stored. A correction amount corresponding to a deformation property detected from the plurality of types of deformation properties stored in the storage section 52 is selected, and the third drive signal ComA can be corrected using the selected correction amount of the third drive signal ComA corresponding to the detected deformation property.

However, the first deformation property preferably indicates a change in the amount of deformation of the piezoelectric element 34 that corresponds to a change in the difference D in electrical potential between the first electrode Zu and the second electrode Zd. The change in the amount of deformation of the piezoelectric element 34 that corresponds to the change in the difference D in electrical potential between the first electrode Zu and the second electrode Zd corresponds to a hysteresis curve of the piezoelectric element 34, and the coercive voltage can be obtained. For example, in addition to the coercive voltage, the first deformation property may be a voltage or the like corresponding to specific polarization in the hysteresis curve of the piezoelectric element 34. Similarly, the second deformation property preferably indicates a change in the amount of deformation of the piezoelectric element 34 that corresponds to a change in the difference D in electrical potential between the first electrode Zu and the second electrode Zd. In addition, the second deformation property may be a voltage or the like corresponding to specific polarization in the hysteresis curve of the piezoelectric element 34.

In addition, as described above, the drive signal generator 54 generates the third drive signal ComA related to ejection. The third drive signal ComA includes the ejection electrical potential-changing elements E1 and E2 illustrated in FIG. 5. The ejection electrical potential-changing elements E1 and E2 are elements that are supplied to the first electrode Zu to deform the piezoelectric element 34 so as to cause the pressure applied to the ink in the pressure chamber C1 to fluctuate to the extent that the ink is ejected from the nozzle N communicating with the pressure chamber C1. The first deformation property is identified using the first drive signals ComB different from the third drive signal ComA.

The degradation of the piezoelectric element 34 progresses depending on the voltage applied, an environmental temperature, and an environmental humidity. Therefore, when printing is continuously performed using the predetermined third drive signal ComA at a predetermined temperature and a predetermined humidity, it is also possible to predict the progress of degradation to a certain extent from an energization period. However, the shape of a waveform including the electrical potential of the third drive signal ComA related to ejection may be changed from the shape of the waveform during the manufacture to set an amount of ink to be ejected and the ejection speed to a desired amount of ink to be ejected and a desired ejection speed that are suitable for printing. In addition, an environment in which the liquid ejecting apparatus 100 is installed may vary. Therefore, it has been difficult to estimate degradation of the piezoelectric element 34 from a cumulative time of driving the piezoelectric element 34 simply using the third drive signal ComA, or the like. However, according to the above-described method, the current first deformation property of the piezoelectric element 34 is identified using the first drive signals ComB. Therefore, it is possible to estimate degradation of the piezoelectric element 34 based on the current deformation property of the piezoelectric element 34 detected using the first drive signals ComB, instead of estimating degradation of the piezoelectric element 34 from a cumulative time of applying the third drive signal ComA that may be different from that in the actual usage state or the like.

The drive signal generator 54 generates the third drive signal ComA corrected according to the difference between the first and second deformation properties included in the property information. In this manner, the waveform included in the third drive signal ComA related to ejection is corrected. Specifically, the lowest electrical potential EL1 and the highest electrical potential EH1 of the ejection electrical potential-changing element E1 and the lowest electrical potential EL2 and the highest electrical potential EH2 of the ejection electrical potential-changing element E2 are set. By using the property information including the difference between the deformation properties of the piezoelectric element 34 detected using the common first drive signals ComB at the first timing and the second timing, the waveform of the third drive signal ComA related to ejection can be corrected based on the difference included in the more accurate property information of the piezoelectric element at the first timing and the second timing. Therefore, even when the piezoelectric element 34 is driven for a long period of time, it is possible to suppress a decrease in the printing quality.

In addition, in the examples illustrated in FIGS. 9 and 10 described above, in the plurality of pairs, the electrical potentials of the first drive signals ComB are equal to each other and the waveforms of the first drive signals ComB are equal to each other. Therefore, in the plurality of pairs, the highest electrical potentials EH3 corresponding to the starting electrical potentials of the electrical potential-changing elements E3 of the first drive signals ComB are equal to each other and the lowest electrical potentials EL3 corresponding to the ending electrical potentials of the electrical potential-changing elements E3 of the first drive signals ComB are equal to each other. Therefore, in the plurality of pairs, the differences between the highest electrical potentials EH3 and the lowest electrical potentials EL3 are equal to each other. On the other hand, the electrical potentials of the electrical potential-maintained elements E4 of the second drive signals VBS are different from each other for the plurality of pairs. Therefore, it is possible to detect correlation between the differences D between the electrical potentials and the residual vibration signals Vout without considering a fluctuation in the difference between the highest electrical potential EH3 and the lowest electrical potential EL3 of the electrical potential-changing element E3.

The electrical potentials of the second drive signals VBS can be more easily changed than the electrical potentials of the first drive signals ComB. Therefore, by changing the electrical potentials of the electrical potential-maintained elements E4 of the second drive signals VBS, it is possible to easily generate the plurality of pairs in which the differences D between the electrical potentials are different from each other.

In addition, when the electrical potential-changing element E3 of the first drive signal ComB is supplied, the volume of the pressure chamber C1 when the highest electrical potential EH3 corresponding to the starting electrical potential is applied is less than the volume of the pressure chamber C1 when the lowest electrical potential EL3 corresponding to the ending electrical potential is applied. That is, when the electrical potential-changing element E3 is supplied, a meniscus in the nozzle N is drawn toward the pressure chamber C1 side and is not drawn in a direction in which droplets are ejected. Since the electrical potentials change in the above-described manner, it is possible to more reliably prevent the ink from being ejected from the nozzle N by the driving of the piezoelectric element 34.

In addition, as described above, at the first timing, the first deformation property is identified. At the second timing, the second deformation property is identified. The detector 50 determines a degree of degradation of the piezoelectric element 34 based on the difference between the first deformation property and the second deformation property. The degree of degradation of the piezoelectric element 34 is an example of a state of change in the deformation property of the piezoelectric element 34. By using two or more deformation properties identified at different two or more timings, it is possible to estimate the state of change in the deformation property of the piezoelectric element 34. Therefore, the third drive signal ComA related to ejection can be corrected based on the estimated state of change in the deformation property.

The first deformation property is identified from amplitude states of the plurality of residual vibration signals Vout detected at the first timing. Similarly, the second deformation property is identified from amplitude states of the plurality of residual vibration signals Vout detected at the second timing. The residual vibration signals Vout are generated by the piezoelectric effect of the piezoelectric element 34. Therefore, a change in the piezoelectric effect due to degradation of the piezoelectric element 34 appears as a change in the amplitude states of the residual vibration signals Vout, and thus the deformation properties can be identified using the amplitude states of the residual vibration signals Vout.

The first deformation property is identified based on correlation between the difference D between the electrical potentials and a spectral intensity of a predetermined frequency component obtained by frequency analysis of the plurality of residual vibration signals Vout detected at the first timing. Similarly, the second deformation property is identified based on correlation between the difference D between the electrical potentials and a spectral intensity of a predetermined frequency component obtained by frequency analysis of the plurality of residual vibration signals Vout detected at the second timing. Since the deformation properties are obtained using the frequency analysis, it is possible to easily and quickly identify the deformation properties.

In addition, the first deformation property is the coercive voltage of the piezoelectric element identified from the correlation between the difference D between the electrical potentials and the spectral intensity of the predetermined frequency component obtained from the frequency analysis of the plurality of residual vibration signals Vout detected at the first timing. Similarly, the second deformation property is the coercive voltage of the piezoelectric element identified from the correlation between the difference D between the electrical potentials and the spectral intensity of the predetermined frequency component obtained from the frequency analysis of the plurality of residual vibration signals Vout detected at the second timing. That is, the first deformation property and the second deformation property are the coercive voltages, as described above. Capturing a change in the coercive voltage is suitable for estimating degradation of the piezoelectric element 34. Therefore, since the deformation properties are obtained using the frequency analysis, it is possible to easily and quickly identify the deformation properties with high accuracy.

In addition, the deformation properties may be identified using a method other than the frequency analysis. For example, the deformation properties may be identified using curve fitting processing. Specifically, the first deformation property may be identified based on correlation between the difference D between the electrical potentials and an amplitude of residual vibration obtained by performing the curve fitting processing on the plurality of residual vibration signals Vout detected at the first timing. Similarly, the second deformation property may be identified based on correlation between the difference D between the electrical potentials and an amplitude of residual vibration obtained by performing the curve fitting processing on the plurality of residual vibration signals Vout detected at the second timing.

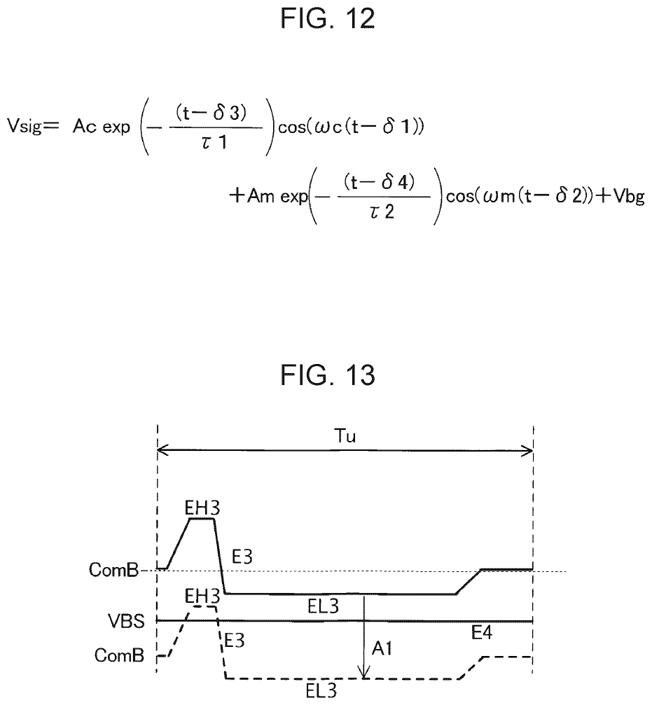

FIG. 12 illustrates a model equation for the curve fitting processing. In the model equation illustrated in FIG. 12, Ac is the amplitude of the residual vibration. τ1 is a damping time constant of the residual vibration. 83 is the phase of a damping component of the residual vibration. ωc is each frequency of the residual vibration. δ1 is the phase of a vibration component of the residual vibration. τ2 is a damping time constant of vibration of a circuit. δ4 is the phase of a damping component of the vibration of the circuit. ωm is each frequency of the vibration of the circuit. δ2 is the phase of a vibration component of the vibration of the circuit. Vbg is a background voltage. For example, Vbg corresponds to the lowest electrical potential EL3 of the first drive signal ComB. Vsig is a coefficient for a vibration component of the natural vibration frequency of the piezoelectric element 34.

The detector 50 calculates, for each of the pairs, the coefficient Vsig for the vibration component of the natural vibration frequency of the residual vibration by curve fitting. Then, the detector 50 detects the minimum value among the coefficients Vsig for the plurality of pairs and identifies the difference D between the electrical potentials that corresponds to the minimum value as the coercive voltage, that is, as the deformation property. It is possible to quickly and easily obtain the deformation property by using the curve fitting processing.

### 2. Second Embodiment

In an embodiment exemplified below, the reference signs used for the description of the first embodiment will be used for elements whose effects and functions are the same as or similar to those described above in the first embodiment, and detailed description of each of the elements will be omitted as appropriate. In the second embodiment, a step of detecting residual vibration signals Vout in step S01 is different from that in the first embodiment.

FIG. 13 is a diagram for explaining step S01 according to the second embodiment. In the present embodiment, in step S01, the drive signal generator 54 generates second drive signals VBS including electrical potential-maintained elements E4 having predetermined fixed electrical potentials, and first drive signals ComB having electrical potentials different in sequence, and thereby generates a plurality of pairs of the first drive signals ComB and the second drive signals VBS.

As illustrated in FIG. 13, the shape of the waveform of the first drive signal ComB is not changed, while the electrical potential of the entire first drive signal ComB is changed. For example, the plurality of pairs are generated by decreasing the electrical potential from the first drive signal ComB indicated by a solid line to the first drive signal ComB indicated by a broken line as indicated by an arrow A1. In the present embodiment, the electrical potentials of the second drive signals VBS are not changed. Therefore, in the plurality of pairs, the electrical potentials of the second drive signals VBS are equal to each other and the waveforms of the of the second drive signals VBS are equal to each other.

In the present embodiment, in the plurality of pairs, the electrical potentials of the first drive signals ComB are different from each other. Therefore, in the plurality of pairs, the lowest electrical potentials EL3 corresponding to the ending electrical potentials of the electrical potential-changing elements E3 of the first drive signals ComB are different from each other. On the other hand, in the plurality of pairs, the electrical potentials of the electrical potential-maintained elements E4 of the second drive signals VBS are equal to each other. Therefore, the differences D in electrical potential between the first drive signals ComB and the second drive signals VBS are different for the pairs.

Also in the present embodiment, similarly to the first embodiment, the plurality of pairs in which the differences D between the electrical potentials are different from each other can be generated by changing the electrical potential of the first drive signal ComB.

In addition, in the present embodiment, in the plurality of pairs, the differences between the highest electrical potentials EH3 corresponding to the starting electrical potentials of the electrical potential-changing elements E3 and the lowest electrical potentials EL3 corresponding to the ending electrical potentials of the electrical potential-changing elements E3 are equal to each other. The plurality of pairs in which the differences D between the electrical potentials are different from each other can be easily generated by making the first drive signals ComB different for the pairs without changing the differences between the highest electrical potentials EH3 and the lowest electrical potentials EL3. Therefore, the correlation between the differences D between the electrical potentials and the residual vibration signals Vout can be detected without considering a fluctuation in the differences between the highest electrical potentials EH3 and the lowest electrical potentials EL3 of the electrical potential-changing elements E3 in the plurality of pairs.

### 3. Modifications

Each of the embodiments exemplified above can be variously modified. Specific modifications that can be applied to each of the embodiments described above are exemplified as follows. Two or more aspects randomly selected from the following examples can be combined as appropriate to the extent that the aspects do not contradict each other.

In the above-described embodiments, in each of the pairs, either the first drive signal ComB or the second drive signal VBS is changed. However, in each of the pairs, both of the first drive signal ComB and the second drive signal VBS may be changed. It suffices for the differences D between the electrical potentials to be different for the plurality of pairs.

In addition, in the above-described embodiments, the deformation properties are identified at the two timings, which are the first timing and the second timing, but deformation properties may be identified at three or more timings.

In addition, the liquid ejecting apparatus 100 may include a circulation mechanism that circulates the ink in the flow path in the head chip 3.

In addition, in the above-described embodiments, each of the piezoelectric elements 34 is provided for a respective one of the nozzles N, but a plurality of piezoelectric elements 34 may be provided for each of the nozzles N.

In the above-described embodiments, the serial type liquid ejecting apparatus 100 that causes the carriage 231 on which the liquid ejecting head 20 is mounted to reciprocate is exemplified, but the present disclosure is also applied to a line type liquid ejecting apparatus in which a plurality of nozzles N are distributed over the entire width of the medium 11.

The liquid ejecting apparatus 100 exemplified in each of the embodiments may be used in not only an apparatus dedicated for printing but also various apparatuses such as a facsimile machine and a copy machine, and the use of the present disclosure is not particularly limited. The use of the liquid ejecting apparatus is not limited to printing. For example, a liquid ejecting apparatus that ejects a solution of a coloring material is used as a manufacturing apparatus that forms a color filter for a display device such as a liquid display panel. In addition, a liquid ejecting apparatus that ejects a solution of a conductive material is used as a manufacturing apparatus that forms a wiring line and an electrode of a wiring substrate. Further, a liquid ejecting apparatus that ejects a solution of organic matter related to a living organism is used as, for example, a manufacturing apparatus that manufactures a biochip.

Although the present disclosure is described based on the preferred embodiments, the present disclosure is not limited to the above-described embodiments. In addition, the configurations of the sections described in the present disclosure can be replaced with any configurations that have the same functions as those described above in the embodiments, and any configuration can be added to each of the configurations of the sections described in the present disclosure.

What is claimed is:

1. A method of driving a liquid ejecting apparatus including
a piezoelectric element having a first electrode, a second electrode, and a piezoelectric body disposed between the first electrode and the second electrode,
a pressure chamber having a volume that changes according to deformation of the piezoelectric element,
a drive signal generator that is configured to generate a pair of a first drive signal and a second drive signal, the first drive signal including an electrical potential-changing element that change in electrical potential over predetermined electrical potential differences from starting electrical potential to ending electrical potential, and the second drive signal including an electrical potential-maintained element that maintain fixed electrical potential, and
a detector that is configured to detect, as a residual vibration signal, variations in electromotive force of the piezoelectric element according to variations in residual pressure in liquid in the pressure chamber after the electrical potential-changing element is supplied to the first electrode while the electrical potential-maintained element is supplied to the second electrode, the method comprising:
generating a plurality of the pair of the first drive signals and the second drive signals, differences between the ending electrical potentials of the electrical potential-changing elements of the first drive signals and the electrical potentials of the electrical potential-maintained elements of the second drive signals are different each other in the plurality of pairs;
detecting a plurality of the residual vibration signals for the plurality of pairs; and
identifying a first deformation property of the piezoelectric element based on the plurality of the residual vibration signals for the plurality of pairs.

2. The method of driving the liquid ejecting apparatus according to claim 1, wherein the first deformation property includes a coercive voltage of the piezoelectric element.

3. The method of driving the liquid ejecting apparatus according to claim 1, wherein the first deformation property indicates a change in an amount of the deformation of the piezoelectric element, the change corresponding to a change in a difference in electrical potential between the first electrode and the second electrode.

4. The method of driving the liquid ejecting apparatus according to claim 1, wherein generating a third drive signal that is supplied to the first electrode and includes an ejection electrical potential-changing element that deforms the piezoelectric element to cause the pressure applied to the liquid in the pressure chamber to fluctuate to an extent that a droplet is ejected from a nozzle communicating with the pressure chamber, and
a lowest electrical potential and a highest electrical potential of the ejection electrical potential-changing element are set according to property information including the first deformation property.

5. The method of driving the liquid ejecting apparatus according to claim 1, wherein the ending electrical potentials of the electrical potential-changing elements of the first drive signals are different for the plurality of pairs, and
the electrical potentials of the electrical potential-maintained elements of the second drive signals are equal for the plurality of pairs.

6. The method of driving the liquid ejecting apparatus according to claim 1, wherein the ending electrical potentials of the electrical potential-changing elements of the first drive signals are equal for the plurality of pairs, and
the electrical potentials of the electrical potential-maintained elements of the second drive signals are different for the plurality of pairs.

7. The method of driving the liquid ejecting apparatus according to claim 1, wherein when the electrical potential-changing elements of the first drive signals are supplied, a volume of the pressure chamber when the starting electrical potentials are supplied is less than a volume of the pressure chamber when the ending electrical potentials are supplied.

8. The method of driving the liquid ejecting apparatus according to claim 1, wherein the differences between the starting electrical potentials and the ending electrical potentials of the electrical potential-changing elements are equal for the plurality of pairs.

9. The method of driving the liquid ejecting apparatus according to claim 1, further comprising:
at a first timing, identifying the first deformation property for each of the plurality of pairs; and
at a second timing after a predetermined period of time from the first timing,
generating the plurality of the pair of the first drive signals and the second drive signals,
detecting the plurality of the residual vibration signals for the plurality of the pair,
identifying a second deformation property of the piezoelectric element based on the plurality of the residual vibration signals for the plurality of pairs, and
determining a state of change in a deformation property of the piezoelectric element based on a difference between the first deformation property and the second deformation property.

10. The method of driving the liquid ejecting apparatus according to claim 9, wherein identifying the first deformation property identified from amplitude states of the plurality of residual vibration signals detected at the first timing, and
identifying the second deformation property from amplitude states of the plurality of residual vibration signals detected at the second timing.

11. The method of driving the liquid ejecting apparatus according to claim 10, wherein identifying the first deformation property based on correlation between a spectral intensity of a predetermined frequency component obtained from frequency analysis of the plurality of residual vibration signals detected at the first timing, and differences between the ending electrical potentials of the electrical potential-changing elements and the electrical potentials of the electrical potential-maintained elements, and
identifying the second deformation property based on correlation between a spectral intensity of a predetermined frequency component obtained from frequency analysis of the plurality of residual vibration signals detected at the second timing, and the differences between the ending electrical potentials of the electrical potential-changing elements and the electrical potentials of the electrical potential-maintained elements.

12. The method of driving the liquid ejecting apparatus according to claim 11, wherein identifying, as the first deformation property, a first coercive voltage of the piezoelectric element from the correlation between the spectral intensity of the predetermined frequency component obtained from the frequency analysis of the plurality of residual vibration signals detected at the first timing, and the differences between the ending electrical potentials of the electrical potential-changing elements and the electrical potentials of the electrical potential-maintained elements,
identifying, as the second deformation property, a second coercive voltage of the piezoelectric element from the correlation between the spectral intensity of the predetermined frequency component obtained from the frequency analysis of the plurality of residual vibration signals detected at the second timing, and the differences between the ending electrical potentials of the electrical potential-changing elements and the electrical potentials of the electrical potential-maintained elements, and
determining the state of change in the deformation property of the piezoelectric element based on a difference between the coercive voltage of the piezoelectric element that is the first deformation property and the coercive voltage of the piezoelectric element that is the second deformation property.

13. The method of driving the liquid ejecting apparatus according to claim 10, wherein identifying the first deformation property based on correlation between an amplitude of residual vibration obtained by performing curve fitting processing on the plurality of residual vibration signals detected at the first timing, and the differences between the ending electrical potentials of the electrical potential-changing elements and the electrical potentials of the electrical potential-maintained elements, and
identifying the second deformation property based on correlation between an amplitude of residual vibration obtained by performing curve fitting processing on the plurality of residual vibration signals detected at the second timing, and the differences between the ending electrical potentials of the electrical potential-changing elements and the electrical potentials of the electrical potential-maintained elements.
